(19) United States
(12) Patent Application Publication
(10) Pub. No.: US 2002/0069201 A1
(43) Pub. Date: Jun. 6, 2002

(54) Method for downloading selectable progressive mesh models under the environment of World Wide Web

(76) Inventor: Yu-Jung Cheng, Taipei (TW)

Correspondence Address: BACON & THOMAS, PLLC, 625 Slaters Lane, 4th Floor, Alexandria, VA, 22314-1176, US

(21) Appl. No.: 09/739,705

(22) Filed: Dec. 20, 2000

(30) Foreign Application Priority Data
Dec. 4, 2000 (TW) 89125821

(51) Int. Cl. G06F 7/00

(52) U.S. Cl. 707/10

(57) ABSTRACT

A method for downloading selectable progressive mesh models under the environment of World Wide Web is disclosed. The converted progressive mesh model is stored in a database installed in the World Wide Web server by a relational database format. The LOD ID of a progressive mesh model is used as a primary key of the database. By using the existing program service, the Mesh data of some layer can be requested in a network by a HTTP with LOD ID (LID). Therefore, under the current World Wide Web environment, no new server program is necessary, while only the current service program of CGI/ASP/PHP is used to download the data of progressive mesh model of some layer.

### BACKGROUND OF THE INVENTION

1. Field of the Invention

The present invention relates to a method for downloading progressive mesh models, and more particularly, to a method for downloading a selectable progressive mesh models under the environment of World Wide Web.

2. Description of Related Art

Currently, with the popularity of Internet, information all over the world can be acquired through World Wide Web. But with the increasing of data amount, the bandwidths of current networks are insufficient. Therefore, in order to provide a better network transmission quality, other than expanding the bandwidth of a network, the data flow of a network is necessary to be controlled.

In the P.H.D Dissertation of Dip. -Ing Dieter Schmalstieg, “The Remote Rendering Pipeline, Managing Geometry and Bandwidth in Distributed Virtual Environments”, a method using octtree and vertex cluster is disclosed for converting a 3D model with polygonal mesh into a progressive mesh (PM) model architecture with a level of detail mesh (LOD mesh). The advantage of LOD mesh is that it is formed by a simplified base model and a plurality of refined models. Therefore, when a 3D browser is desired to check some object, the base model of LOD mesh with less data can be downloaded. Then, as required, the data of the plurality of refined model is downloaded for controlling the displaying quality and the network data flow.

Under the environment of World Wide Web, the data of a polygonal mesh is very large. Thus, when the user of the client end is desired to search for a model and if no progressive mesh model technology is used, the user must request to the server end for a model and waiting for a long time in transmission. If the transferred mode is not the desired one, the user must request another model to the server and wait for transferring the model again. Such a request process is repeated until a desired model is acquired. If the server end uses a progressive mesh model technology and the user requests for a model, the server may at first send a base model, and then send a refined one. When the user receives the base mode and determines that it is not the desired one, the transmission can be cancelled before the refined model is completely sent. By this mechanism, the response time of the server to the client can be reduced. Moreover, the use of the bandwidth of a network is saved.

In the aforesaid network environment, the amount of data is important. Thus, the progressive mesh model technology suitable for such a network transmission must be able to generate a progressive mesh model with a small data amount. Conventionally, the data of the progressive mesh model is appended with a LOD identification (LOD ID), such that, through this LOD identification, a specific level of a model can be identified and acquired. For example, the LOD ID of a base model is 0; the refined model of first level is 1; and the refined mode of second level is 2. The system architecture of this progressive model is illustrated in FIG. 4. As shown, an extra server 41 is responsible for the transmission of the LOD mesh. When the client end 42 needs a refined data of some model, the client end will send the identification code and LOD ID of the requested object. Then, the server 41 executes a progressive downloading operation according to the request of the client end through a specific protocol so that the refined data is transferred to the user of the client end 42. However, in the aforesaid architecture, an extra standby server 41 is needed, and thus such an architecture is not suitable to be arranged and managed in the current World Wide Web environment. Therefore, there is a desired to be able to effectively and conveniently download progressive mesh models under the environment of the World Wide Web.

### SUMMARY OF THE INVENTION

The object of the present invention is to provide a method for downloading selectable progressive mesh models under the environment of World Wide Web, such that, under the current World Wide Web architecture, there is no new server program required, and only the current service program of CGI/ASP/PHP is used to download the data of progressive mesh models.

To achieve the object, the present invention provides a method for downloading selectable progressive mesh models under the environment of World Wide Web. The method first converts a 3D model into a format of progressive mesh model with a plurality of progressive mesh model levels, wherein each level has a level of detail identification. Next, the converted progressive mesh model is stored in a database by a format of rational database, and the level of detail identifications of a progressive mesh model are used as the primary key of the database. Then, a HTTP request with a level of detail identification is used to access data of a progressive mesh model from the database via a service program provided by the World Wide Web server.

Other objects, advantages, and novel features of the invention will become more apparent from the following detailed description when taken in conjunction with the accompanying drawings.

### BRIEF DESCRIPTION OF THE DRAWINGS

FIG. 1 shows a system architecture to execute the method for downloading a selectable progressive mesh models under the environment of World Wide Web according to the present invention.

FIG. 2 is a flowchart of the method for downloading selectable progressive mesh models under the environment of World Wide Web according to the present invention.

FIG. 3 is a schematic view showing that the progressive mesh model converted from a 3D model is stored in a database.

FIG. 4 shows a system architecture of a conventional progressive mesh model.

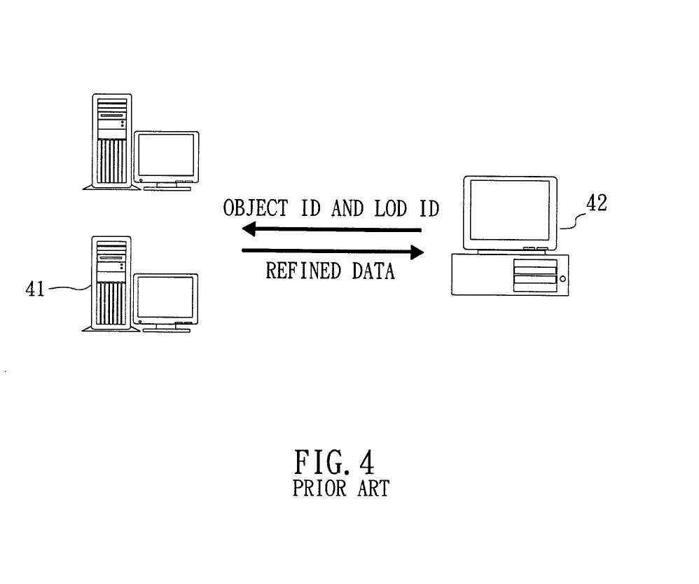

### DETAILED DESCRIPTION OF THE PREFERRED EMBODIMENT

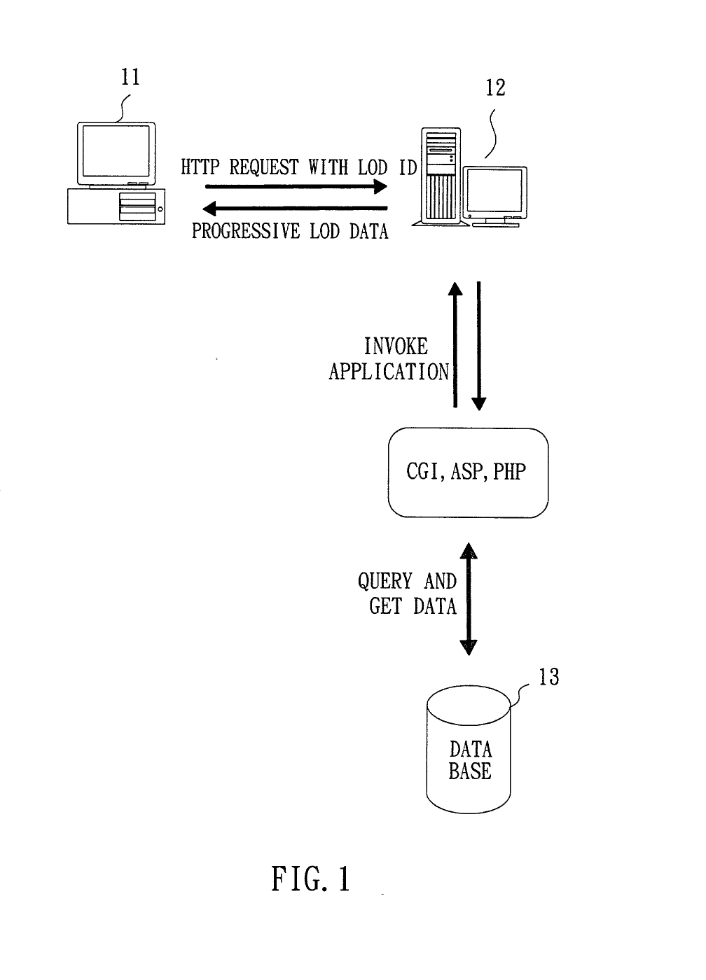

An embodiment of a method for downloading selectable progressive mesh models under the environment of World Wide Web will be described in the following initially with reference to FIG. 1, which shows the system architecture for executing the method. In the environment of World Wide Web, the user of client end 11 uses a HTTP request to acquire information to the server 12 of a network, wherein the server 12 is a general World Wide Web server, such as Apache or IIS.

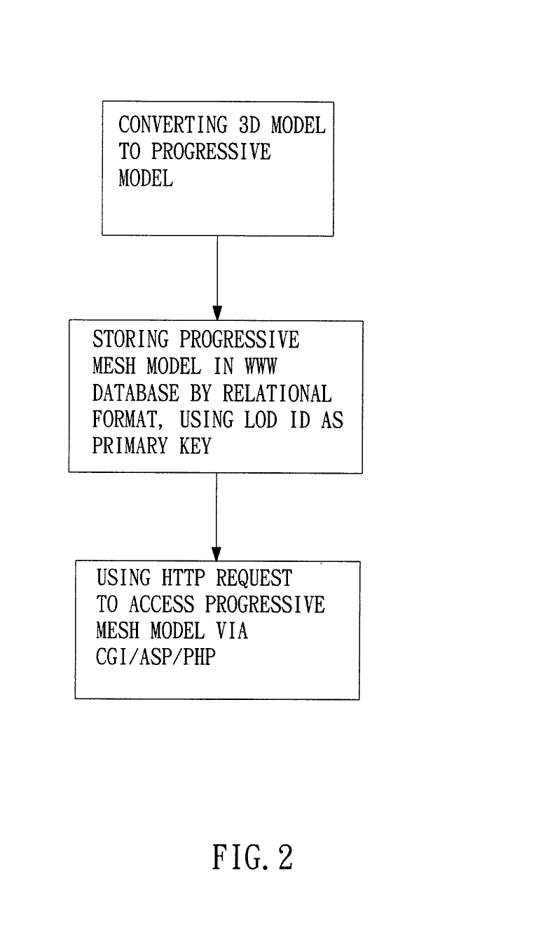

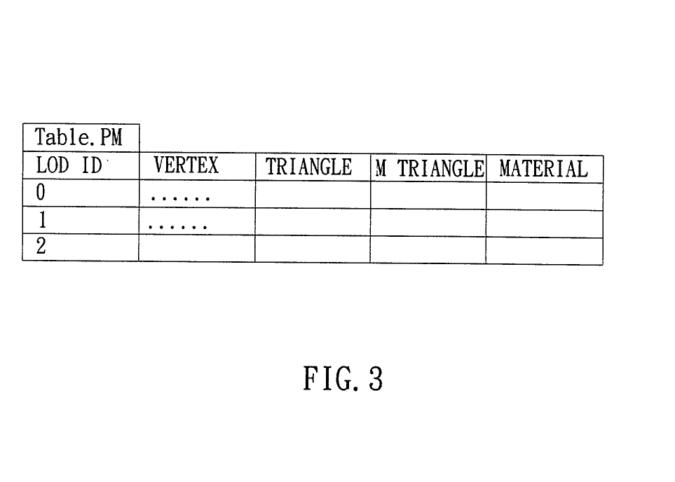

In order to provide the download function of a progressive mesh model, also referring to FIG. 2, which shows the flowchart of the method in accordance with the present invention, the general 3D model is converted into a progressive mesh model format. The conversion process is known by those skilled in the art and thus a detailed description is deemed unnecessary. The converted progressive mesh model is stored in a database 13 installed in the World Wide Web server 12 by a relational database format. The LOD ID of a progressive mesh model is used as a primary key of the database. For example, referring to FIG. 3, a 3D model is represented by a base model with a LOD ID being 0, a first level refined model with LOD ID being 1, and a second level refined model with LOD ID being 2, and is stored in a progressive mesh model table (Table. PM). The LOD IDs (0, 1, 2) are provided to be used as primary key for accessing the database 13. The database 13 is managed by a relational database management program, such as the Access program.

With the aforesaid database 13 stored with progressive mesh model, if data of a specific level of a progressive mesh model is desired to be acquired, it can be obtained from the following SQL syntax query:

SELECT *

FROM “Table.PM”

WHERE “LID=5”.

Referring to FIG. 1 again, the database 13 is arranged under the World Wide Web server 12. Therefore, via the existing program service, such as CGI, ASP or PHP, the Mesh data of a specific level can be accessed in the network by a HTTP request with a LOD ID (LID). For example, the client end 11 may access the data of progressive mesh model by the following HTTP request:

“GET http://mvr.iii.org.tw/PLOD.cgi?LID=5&PM=TABLE.PM”.

Accordingly, the World Wide Web server will invoke CGI, ASP or PHP service program, and the LOD ID is employed as a primary key to query the database 13 for acquiring data of progressive mesh model in a specific level. Therefore, under the current World Wide Web environment, no new server program is necessary, while only the current service program of CGI/ASP/PHP is used to download the data of progressive mesh model of some level.

Although the present invention has been explained in relation to its preferred embodiment, it is to be understood that many other possible modifications and variations can be made without departing from the spirit and scope of the invention as hereinafter claimed.

What is claimed is:

1. A method for downloading selectable progressive mesh models under the environment of World Wide Web, which uses a World Wide Web server and a database under the World Wide Web server to perform download operations for a 3D model, the method comprising the steps of:
(A) converting the 3D model into a format of progressive mesh model with a plurality of progressive mesh model levels, each level having a level of detail identification;
(B) storing the converted progressive mesh model in the database by a format of rational database, and the level of detail identifications of a progressive mesh model being used as a primary key of the database; and
(C) using a HTTP request with a level of detail identification to access data of a progressive mesh model from the database via a service program provided by the World Wide Web server.

2. The method for downloading selectable progressive mesh models under the environment of World Wide Web as claimed in claim 1, wherein in step (A), the larger of the level detail identification is, the more refined the progressive mesh model is.

3. The method for downloading selectable progressive mesh models under the environment of World Wide Web as claimed in claim 1, wherein a level detail identification of 0 represents a base model.

4. The method for downloading selectable progressive mesh models under the environment of World Wide Web as claimed in claim 1, wherein in step (B), a SQL syntax is used to acquire data of the progressive mesh model of a specific level from the database stored with the progressive mesh model.

5. The method for downloading selectable progressive mesh models under the environment of World Wide Web as claimed in claim 1, wherein in step (C), the service program is CGI, ASP or PHP.
